(19) United States
(12) Patent Application Publication
(10) Pub. No.: US 2009/0321443 A1
(43) Pub. Date: Dec. 31, 2009

(54) Method for filling a vessel with a gas entrained beverage and a consumable consumer product including the beverage

(76) Inventors: Jeffrey S. Taggart, McLean, VA (US); William E. Rabbitt, Solon, OH (US); Jay Tapper, Palm Beach Gardens, FL (US)

Correspondence Address: FAY SHARPE LLP, 1228 Euclid Avenue, 5th Floor, The Halle Building, Cleveland, OH, 44115, US

(21) Appl. No.: 12/556,719

(22) Filed: Sep. 10, 2009

Related U.S. Application Data
(63) Continuation-in-part of application No. 12/496,051, filed on Jul. 1, 2009.
Application No. 12/496,051 is a continuation-in-part of application No. 12/414,199, filed on Mar. 30, 2009.
Application No. 12/414,199 is a continuation-in-part of application No. 12/264,023, filed on Nov. 3, 2008.
Application No. 12/264,023 is a continuation-in-part of application No. 12/040,062, filed on Feb. 29, 2008.
Application No. 12/040,062 is a continuation-in-part of application No. 12/014,875, filed on Jan. 16, 2008.
Application No. 12/014,875 is a continuation-in-part of application No. 11/684,326, filed on Mar. 9, 2007.

(51) Int. Cl. B65B 7/00; B65B 3/04; B67D 5/06

(52) U.S. Cl. 220/200; 141/1; 222/464.1; 220/707

(57) ABSTRACT

A method for filling a vessel with a gas entrained beverage includes providing a vessel and a cap assembly, wherein the cap assembly includes a closure including a beverage outlet opening, a hollow dip tube connected with the closure and in fluid communication with the beverage outlet opening via a beverage outlet path, and a valve connected to the closure and disposed along the beverage outlet path. The method further includes filling the vessel with a gas entrained beverage. The method further includes filling the dip tube at least up to the valve with (1) a flushing liquid, (2) the beverage, or (3) the flushing liquid and the beverage, wherein the flushing liquid has less entrained gas than the beverage. The method further includes connecting the cap assembly to the vessel to seal the vessel, wherein the dip tube extends into the gas entrained beverage within the vessel. A consumable consumer product that includes the beverage is also disclosed.

This application is a continuation-in-part of U.S. patent application Ser. No. 12/496,051, filed Jul. 1, 2009, which is a continuation-in-part of U.S. patent application Ser. No. 12/414,199, filed Mar. 30, 2009, which is a continuation-in-part of U.S. patent application Ser. No. 12/264,023, filed Nov. 3, 2008, which is a continuation-in-part of U.S. patent application Ser. No. 12/040,062, filed on Feb. 29, 2008, which is a continuation-in-part of U.S. patent application Ser. No. 12/014,875, filed Jan. 16, 2008, which is a continuation-in-part of U.S. patent application Ser. No. 11/684,326, filed Mar. 9, 2007, all of which are incorporated herein by reference.

### BACKGROUND

This disclosure is directed to a method for filling a vessel with a gas entrained beverage and a consumable consumer product that includes the beverage. FIGS. 1 and 2 depict a known method for filling a vessel 10 with a gas entrained beverage 12, e.g. beer. With reference to FIG. 1, the vessel 10 is filled with the gas entrained beverage 12 prior to a cap assembly 14 being connected with the vessel 10 to seal the beverage in the vessel. The cap assembly 14 includes a closure 16, which can be a threaded cap, a valve 18 (depicted schematically) connected to the closure, and a dip tube 22 extending downwardly from the valve. The dip tube 22 is in fluid communication with the valve 18 via a beverage outlet path 24 and the closure 16 includes a beverage outlet opening 26, which is also in fluid communication with the beverage outlet path 24, located downstream from the valve 18. To dispense the beverage 12 from the vessel 10, the valve 18 is opened and the beverage exits through the beverage outlet opening 26.

With reference to FIG. 2, after the vessel 10 has been filled to the appropriate level with the beverage 12, the cap assembly 14 is screwed onto a threaded neck 28 of the vessel. This seals the beverage 12 inside the vessel 10. When the cap assembly is screwed onto the neck 28, the valve 18 is in the closed position, i.e. the beverage 24 is precluded from traveling through the valve. Air, which was in the dip tube 22 prior to the cap assembly 14 being threaded onto the vessel, is trapped between the valve 18 and an uppermost level 32 of the beverage in the dip tube. This trapped air, or another gas if the dip tube has been flushed with the other gas to remove the air, can result in a very foamy head on the first few glasses that are dispensed from the vessel. Beer drinkers generally appreciate a glass of beer having a reasonable head. A problem occurs, however, when the glass of beer has an unusually large head.

For vessels that contain a lot of beer, for example a typical half barrel keg in the United States, the line that runs from the tap to the keg provides a fluid path that is similar to the dip tube 22 in the vessel 10 described above. When the typical half barrel keg is changed out, the line between the tap and the keg is drained, which provides a location for gas to be trapped between the tap and the keg. Until the line between the keg and the tap is wetted and filled with beer, the beer that is drawn from the tap can have an undesirably large head. This is not a very large problem, because the amount of beer drawn from the keg having an undesirably large head is very little as compared to the volume of beer remaining in the keg. Accordingly, even if the first few pours from the tap of a freshly tapped keg of beer are wasted, the consumer is not annoyed because the amount of wasted beer is small in comparison to the volume of beer remaining in the keg.

A problem arises, however, when the vessel, such as the vessel 10, is much smaller than a typical half barrel keg. If the first few pours of beer are wasted, then the consumer can be very annoyed because the amount of wasted beer is not so small in comparison to the volume of beer remaining in the vessel.

### BRIEF DESCRIPTION

A method for filling a vessel with a gas entrained beverage that can overcome the aforementioned shortcomings includes providing a vessel and a cap assembly, wherein the cap assembly includes a closure including a beverage outlet opening, a hollow dip tube connected with the closure and in fluid communication with the beverage outlet opening via a beverage outlet path, and a valve connected to the closure and disposed along the beverage outlet path. The method further includes filling the vessel with a gas entrained beverage. The method further includes filling the dip tube at least up to the valve with (1) a flushing liquid, (2) the beverage, or (3) the flushing liquid and the beverage, wherein the flushing liquid has less entrained gas than the beverage. The method further includes connecting the cap assembly to the vessel to seal the vessel, wherein the dip tube extends into the gas entrained beverage within the vessel.

A consumable consumer product that can overcome the aforementioned shortcomings includes a vessel, a gas entrained beverage inside the vessel, a closure connected with the vessel to seal the beverage in the vessel, a seal removably connected with the closure, a hollow dip tube connected with the closure and extending into the vessel, and a valve connected with the dip tube. The closure includes a beverage outlet opening. The seal covers the beverage outlet opening when connected with the closure and the beverage outlet opening is open to ambient when the seal has been removed from the closure. The dip tube is in fluid communication with the beverage outlet opening via a beverage outlet path at least partially defined by the dip tube. The valve is in the beverage outlet path for selectively blocking the beverage from the beverage outlet opening. When the vessel is in an upright position, an uppermost level of the beverage inside the vessel but outside the dip tube is spaced below the beverage outlet opening. When in the upright position a liquid is in contact with the valve prior to the seal being removed from the closure.

### BRIEF DESCRIPTION OF THE DRAWINGS

FIGS. 1 and 2 schematically depict a known method for filling a vessel with a gas entrained beverage.

FIGS. 3-6 schematically depict a consumable consumer product that includes a gas entrained beverage.

FIGS. 7 and 8 schematically depict a method for filling a vessel with a gas entrained beverage that includes filling a dip tube with a flushing liquid through a beverage outlet opening.

FIGS. 9 and 10 schematically depict a method for filling a vessel with a gas entrained beverage that includes filling the dip tube with the flushing liquid through an inlet opening of the dip tube.

FIGS. 11-13 schematically depict a method for filling a vessel with a gas entrained beverage that includes filling the dip tube after a cap assembly has been connected to the vessel.

### DETAILED DESCRIPTION

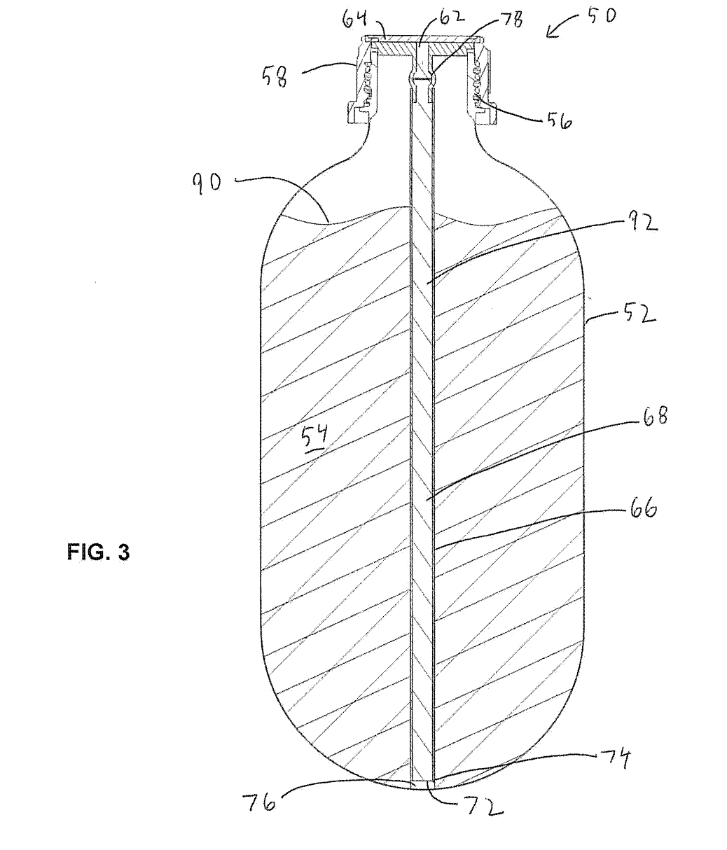

FIG. 3 schematically depicts a consumable consumer product 50 including a vessel 52 and a gas entrained beverage 54 inside the vessel. In the embodiment depicted in FIG. 3, the vessel 52 can be a plastic or glass bottle having a threaded neck 56. The vessel 52 can take other configurations and be made from other material, an example of which will be described in more detail below. The gas entrained beverage 54 can include beer, soda, sparkling wine, and the like. The term “gas entrained beverage” is meant to include consumable beverages where a gas, such as carbon dioxide or nitrogen, is dissolved into the liquid at a pressure such when the vessel 52 is unsealed the gas escapes from the liquid.

With continued reference to FIG. 3, a closure 58 connects with the vessel 52 to seal the beverage in the vessel. The closure 58 also prevents the entrained gas from escaping from the beverage 54 when the closure is connected with the vessel. In the embodiment depicted in FIG. 3, the closure 58 is a threaded cap that threads onto the threaded neck 56 of the vessel 52. The closure can take other configurations, one example of which will be described in more detail below. The closure 58 includes a beverage outlet opening 62 through which the beverage 54 can be dispensed.

With continued reference to the embodiment depicted in FIG. 3, a seal 64 is removably connected with the closure. In the illustrated embodiment, the seal 64 covers the beverage outlet opening 62 when connected with the closure. The seal 64 is removable from the closure 58 in a manner such that the closure is not damaged when the seal is removed from the closure. The seal 64 can be a removable plastic piece, a removable aluminum piece (similar to aluminum foil), or another flexible membrane that can protect the beverage outlet opening 62. The beverage outlet opening 62 is open to ambient when the seal 64 has been removed from the closure.

With continued reference to the embodiment illustrated in FIG. 3, a hollow dip tube 66 connects with the closure 58 and extends into the vessel 54. The dip tube 66 is in fluid communication with the beverage outlet opening 62 via a beverage outlet path 68 at least partially defined by the dip tube. The beverage 54 is dispensed from the vessel 52 via the beverage outlet path 68. In the illustrated embodiment, the hollow dip tube 66 includes an inlet opening 72 formed adjacent a distal end 74 of the dip tube 66. The distal opening 72 of the dip tube 66 in the illustrated embodiment is located near a lowermost inner surface 76 of the vessel 52 so that as much of the beverage 54 as possible can be dispensed from the vessel 52 with the vessel in an upright position (shown in FIG. 3) or a horizontal position.

A valve 78 (depicted schematically) connects with the dip tube 66 and is located in the beverage outlet path 68. In the illustrated embodiment, the valve 78 can be a normally closed valve for selectively blocking the beverage 54 from the beverage outlet opening 62. To dispense the beverage 54 from the vessel 52, an operator opens the valve 78 to allow the beverage to flow through the dip tube 66 via the beverage outlet path 68 toward the beverage outlet opening 62. If desired, pressurized gas via a pressure source (not shown) can enter into the vessel 52 via a gas inlet opening (not shown) to force the beverage 54 through the inlet opening 72 in the dip tube 66. This same pressure source can also provide enough pressure inside the vessel 52 when the valve 78 is closed so that the gas that is entrained in the beverage 54 remains in the beverage. The patent applications mentioned above, each of which are incorporated by reference herein, disclose a dispenser that can be used with the vessel 52 to dispense the beverage 54 from the vessel. The dispenser includes a mechanism for operating the valve 78 as well as mechanisms for providing pressurized gas to the vessel. Since this disclosure is directed to the method for filling the vessel and the consumable consumer product that includes the beverage, further description of the dispenser is not provided herein.

When the vessel 52 is in an upright position (such as that shown in FIGS. 3-6) an uppermost level 90 of the beverage 54 inside the vessel 52 but outside the dip tube 66 is spaced below the beverage outlet opening 62. In the illustrated embodiment, when the vessel is in the upright position, a liquid is in contact with the valve 78 prior to the seal 64 being removed from the closure 58. The valve 78 can include a housing and a sealing member, e.g. a plug, that is movable to allow the beverage to pass through the valve. The liquid that is in contact with the valve 78 can be in contact with all of the components of the valve that are upstream (with reference to the direction in which the beverage is dispensed from the vessel 54) from the sealing member.

In the embodiment depicted in FIG. 3, the liquid that is in contact with the valve 78 is a flushing liquid 92. In this disclosure, the term “flushing liquid” describes a liquid with a very low content of dissolved gases, preferably those experienced naturally from atmospheric exposure, as opposed to a typical carbonated beverage. An example of a flushing liquid that can be used in the consumable consumer product 50 is water, such as distilled water, spring water, tap water, and/or purified water. Accordingly, the flushing liquid 92 has less entrained gas than the beverage 54. The volume of flushing liquid 92 for the embodiment depicted in FIG. 3 is very small as compared to the initial volume (prior to any dispensing) of the beverage 54 inside the vessel 52. For example, where the beverage 54 has an initial volume of at least x mL, the flushing liquid 92 has volume of less than about 0.001x mL. A more particular example is where the initial volume of the beverage 54 is 3 liters, the volume of flushing liquid 92 is less than about 3 mL.

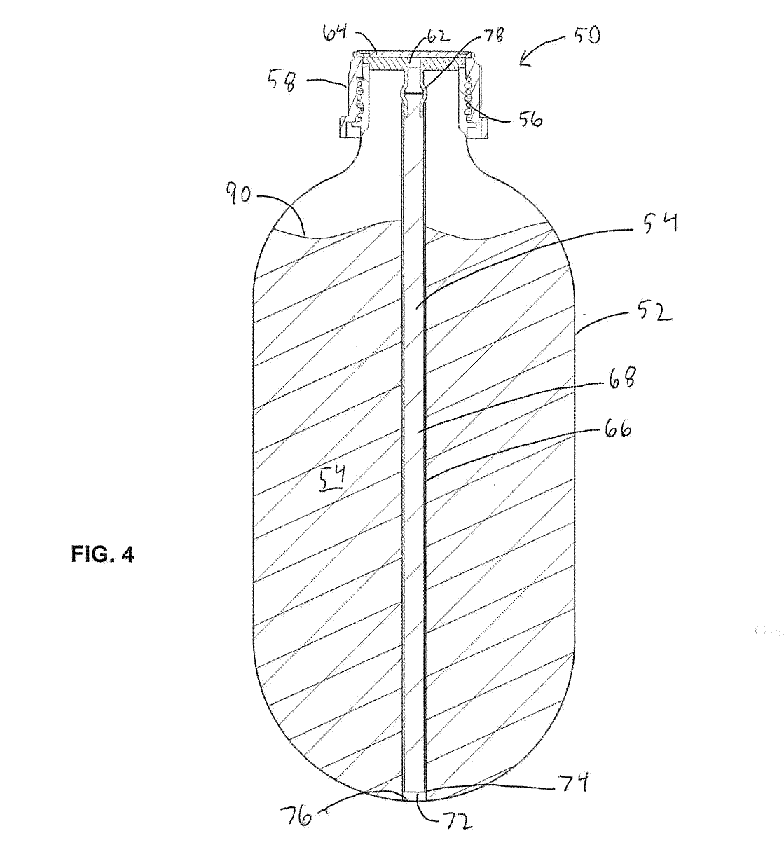

FIG. 4 schematically depicts the consumable consumer product 50 where the liquid that is in contact with the valve 78 is the beverage 54. In this embodiment, the flushing liquid is not found in the dip tube 66.

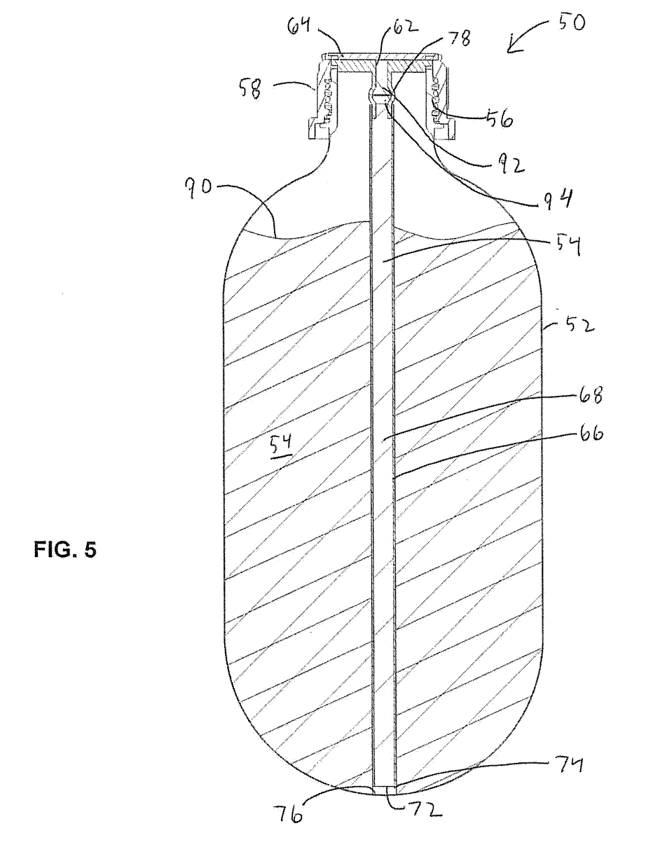

In the embodiment depicted in FIG. 5, the liquid that is in contact with the valve 78 is the flushing liquid 92; however, the entire dip tube 66, i.e. from the distal end 74 to the valve 78, is not filled with the flushing liquid. Instead, in this embodiment the flushing liquid 92 is disposed in the dip tube 66 from an uppermost level 94 of the beverage 54 in the dip tube up to the valve 78.

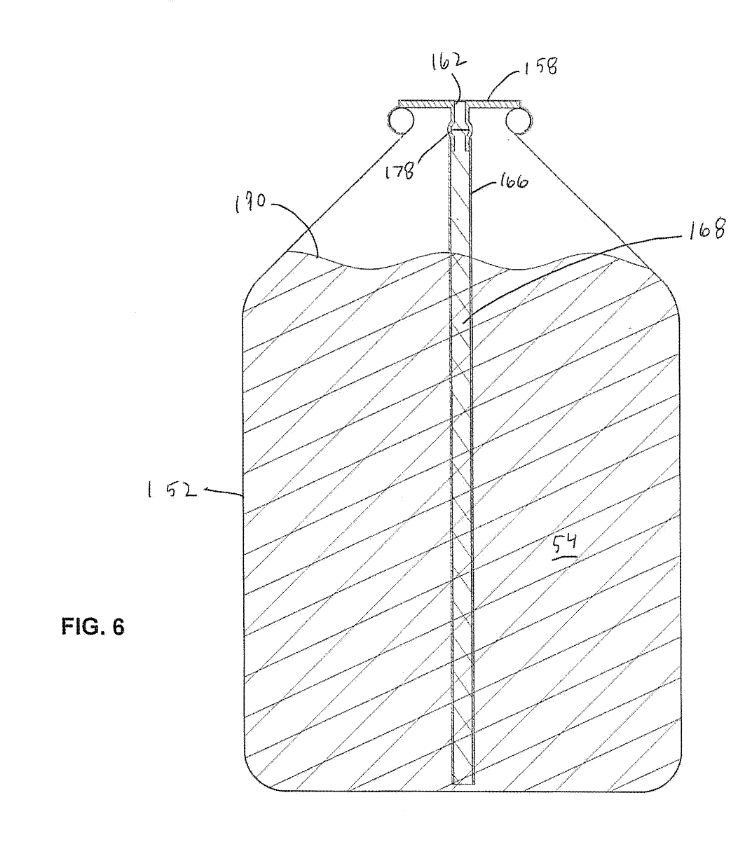

FIG. 6 schematically depicts an alternative embodiment of a vessel 152. In this embodiment, the vessel 152 is similar to a metal can, such as a miniature keg. The gas entrained beverage 54 is inside the vessel 152 and a closure 158 connects with the vessel 152 to seal the beverage 54 in the vessel. In the embodiment illustrated in FIG. 6, the closure 158 also includes a beverage outlet opening 162. In the embodiment depicted in FIG. 6, the closure 158 can connect with the vessel 152 via crimping and/or welding. A seal (not shown) can also removably connect with the vessel 152 to cover the beverage outlet opening 162 when connected with the closure and the beverage outlet opening 162 can be open to ambient when the seal has been removed from the closure. This seal can be similar to the seal 64 that has been described above. In the embodiment illustrated in FIG. 6, a hollow dip tube 166 connects with the closure 158 and extends into the vessel 152. The dip tube 166 is in fluid communication with the beverage outlet opening 162 via a beverage outlet path 168 at least partially defined by the dip tube. The dip tube 166 can be similar to the dip tube 66 described above; therefore, further description thereof will not be provided.

Similar to the embodiments shown in FIGS. 3-5, in the embodiment illustrated in FIG. 6 a valve 178 connects with the dip tube 166 and is disposed in the beverage outlet path 168 for selectively blocking the beverage 54 from the beverage outlet opening 162. The valve 178 operates in a similar manner to the valve 78 described above; therefore, further description thereof has not been provided. Similar to the embodiment described in FIGS. 3-5, for the embodiment illustrated in FIG. 6 when the vessel 152 is in an upright position (such as that shown in FIG. 6) and uppermost level 190 of the beverage 54 inside the vessel but outside the dip tube 166 is spaced below the beverage outlet opening 162. When in the upright position, a liquid, which can include a flushing liquid 192 (shown in FIG. 6) or the beverage 54 is in contact with the valve 178 prior to the seal being removed from the closure.

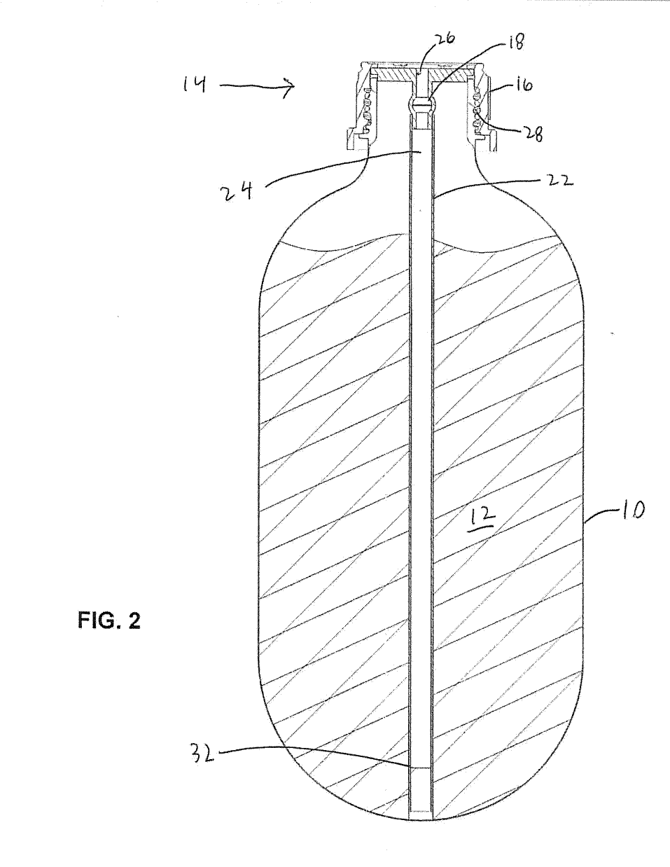

FIGS. 2-6 depict only a few different examples of vessels and closures for a gas entrained beverage. The vessels and closures can take other configurations and can be made from other materials than those described while still being within the scope of the invention.

A method for filling a vessel, e.g. the vessel 52 or the vessel 152, with the gas entrained beverage 54 will be described with particularity to a vessel similarly shaped to that shown in FIGS. 3-5. It should be understood that the method for filling the vessel is also applicable to consumable consumer products similar to the consumable consumer product 150 depicted in FIG. 6. Moreover, the term “filling” as used herein is not meant to indicate that the entire volume of the vessel must be full. Instead, the term “filling” describes adding liquid up to a desired level within a volume. For example, the vessel 52 can be filled to a level where the vessel is half full, one-quarter full, etc.

An example of a method for filling a vessel with a gas entrained beverage includes providing a vessel, such as the vessel 52, and a cap assembly. The cap assembly can include the closure 58, the hollow dip tube 66 and the valve 78 that were described above. The closure 58 can include the beverage outlet opening 62. The hollow dip tube 66 can connect with the closure 58 and be in fluid communication with the beverage outlet opening 62 via the beverage outlet path 68. The valve 78 can connect to the closure 58 and be disposed along the beverage outlet path 68.

The method for filling the vessel further includes filling the vessel 52 with the gas entrained beverage 54. The method can further include filling the dip tube 66 at least up to the valve 78 with (1) the flushing liquid 92, (2) the beverage 54, or (3) the flushing liquid and the beverage. As mentioned above, the flushing liquid 92 has less entrained gas than the beverage 54.

The method for filling the vessel can further include connecting the cap assembly to the vessel 52 to seal the vessel. The cap assembly can be connected such that the dip tube 66 extends into the gas entrained beverage 54 within the vessel 52. The method can further include opening the valve 62 and closing the valve 62.

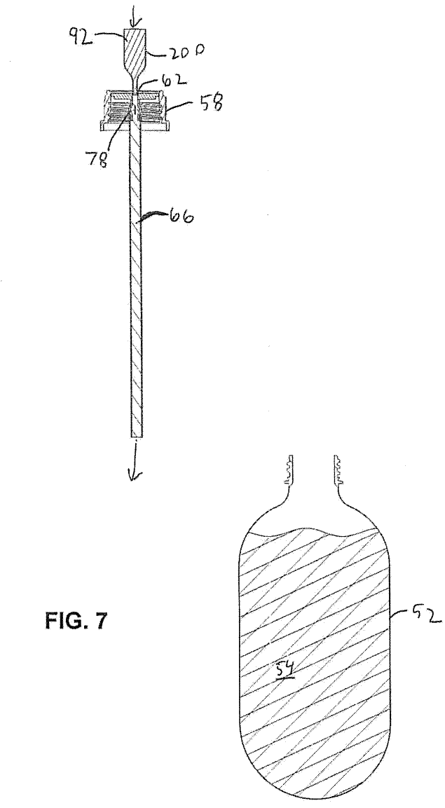

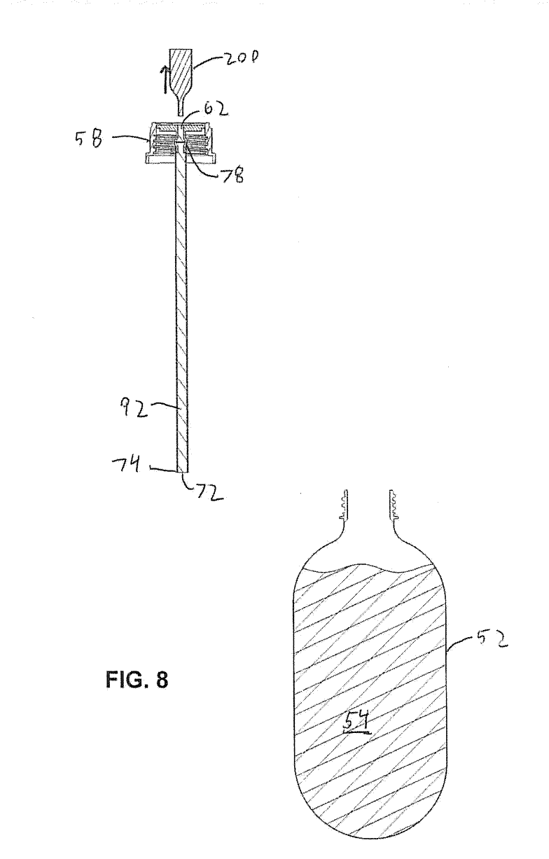

For example, FIGS. 7-10 depict examples of methods where opening the valve 78 and closing the valve are performed before connecting the cap assembly to the vessel 52. With reference to FIGS. 7 and 8, filling the dip tube 66 can be performed through the beverage outlet opening 62. FIG. 7 depicts a flushing liquid spout 200 inserted into (or brought into fluid communication with) the beverage outlet opening 62 of the closure 58. The flushing liquid spout 200 receives flushing liquid 92 from a flushing liquid source (not shown). The valve 78 is opened and flushing liquid 92 is introduced into the dip tube 66 through the beverage outlet opening 62.

When the flushing liquid 92 begins to exit the inlet opening 72 at the distal end 74 of the dip tube 66, the valve 78 is closed (see FIG. 8) and the flushing liquid spout 200 is removed from the beverage inlet opening 62. With the valve 78 in the closed position, the flushing liquid 92 is trapped in the dip tube 66 between the valve 78 and the distal end 74 of the dip tube 66. With the valve 78 still closed, the cap assembly is then connected to the vessel 52 by threading the closure 58 onto the threaded neck 56 to seal the beverage 54 within the vessel 52. Accordingly, the dip tube 66 between the distal end 74 and the valve 78 is filled with the flushing liquid 92 so that no gas and/or very little voids are found in the dip tube for the initial dispensing of the beverage 54 from the vessel 52. With the cap assembly threaded onto the vessel, the consumable consumer product 50 now looks like the embodiment depicted in FIG. 3.

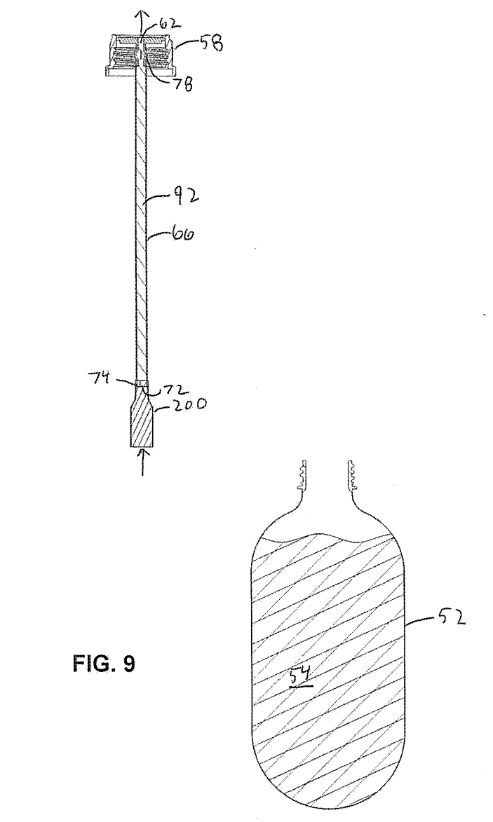

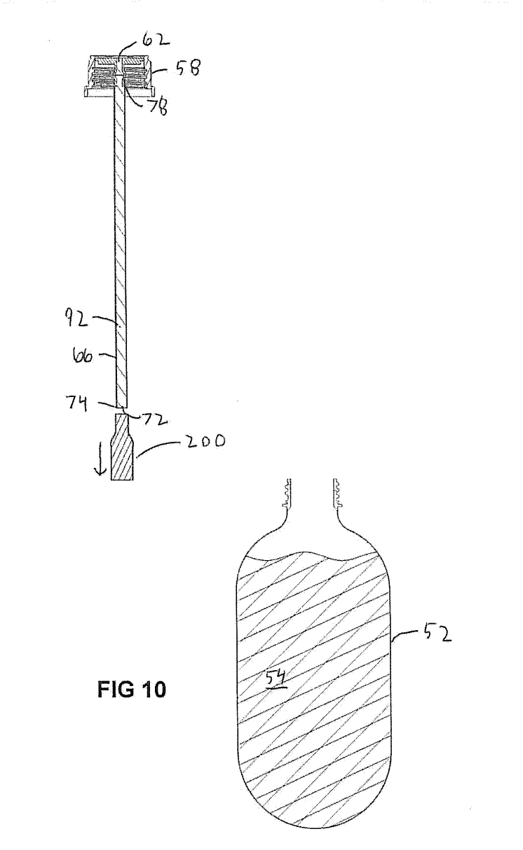

FIG. 9 depicts filling the dip tube 66 from the inlet opening 72 of the dip tube 66. The flushing liquid spout 200, which receives flushing liquid from a flushing liquid source (not shown) is brought in contact with the distal end 74 of the dip tube 66. The flushing liquid 92 is introduced through the inlet opening 72 of the dip tube 66 with the valve 78 in an open position. When the flushing liquid 92 begins to exit the beverage outlet opening 62, the valve 78 is closed (see FIG. 10) and the flushing liquid 92 is trapped in the dip tube 66 between the valve 78 and the inlet 72, which is at the distal end 74 of the dip tube. The cap assembly is then connected to the vessel 52 in a similar manner as that described above and the dip tube 66 is filled with the flushing liquid 92 from the inlet 72 up to the valve 78.

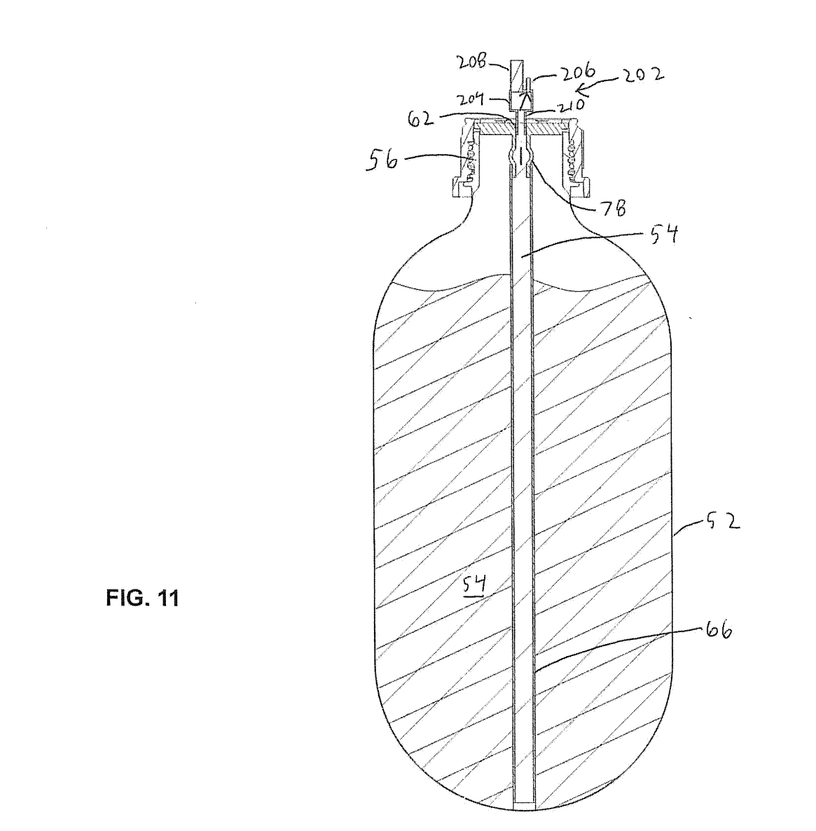

FIG. 11 depicts the method for filling a vessel with a gas entrained beverage where opening the valve 78 and closing the valve are performed after connecting the cap assembly to the vessel 52. FIG. 11 depicts a flushing liquid spout 202 that includes a flushing liquid spout valve 204, a vent line 206, a flushing liquid line 208, and a connector line 210. In the example illustrated in FIG. 11, the connector line 210 is inserted into (or placed in fluid communication with) the beverage outlet opening 62 and the valve 78 is opened. The flushing liquid spout valve 204 is placed in a first operating position which connects the connector line 210 with the vent line 206, which is vented to atmosphere. Since the beverage 54 is under pressure, the beverage will enter the dip tube 66 via the inlet 72 and travel towards the valve 78. The valve 78 can then be closed and the beverage 54 can be in contact with the valve. The filling procedure can end here, which would result in a consumable consumer product similar to the embodiment shown in FIG. 4, or move on to further steps described below.

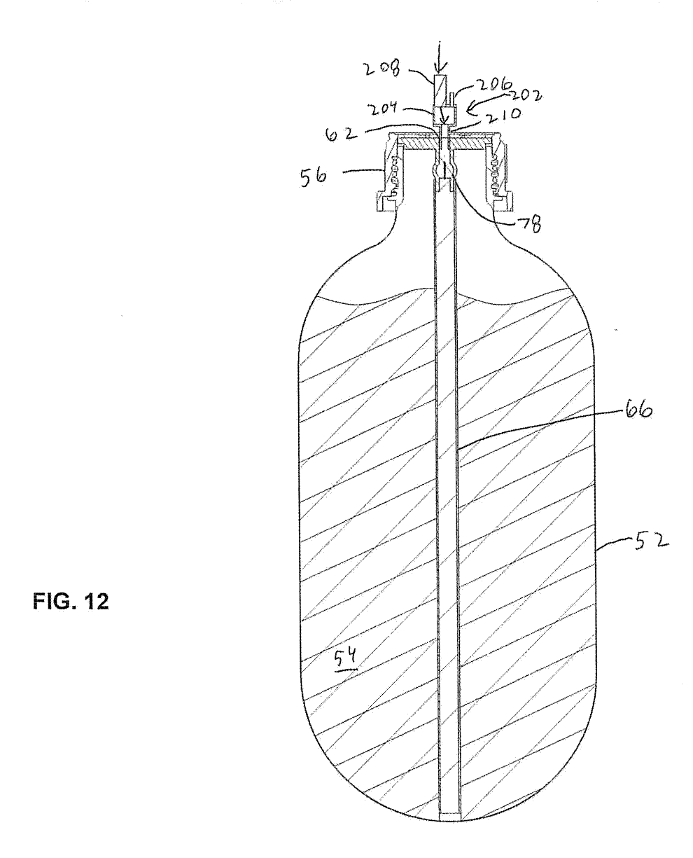

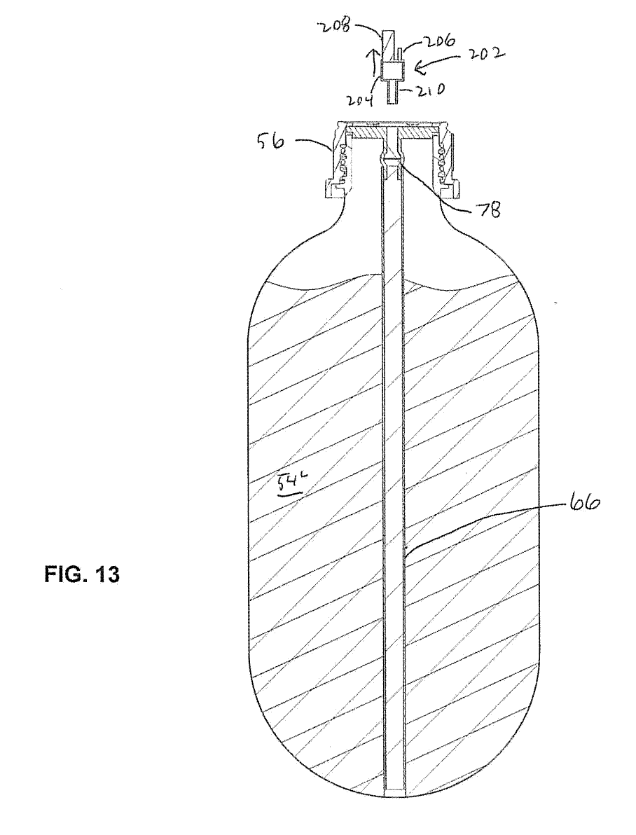

With reference to FIG. 12, the flushing liquid spout valve 204 can be placed in a second operating position where the connector line 210 is connected with the flushing liquid line 208. The flushing liquid line 208 is in fluid communication with a flushing liquid source (not shown). Flushing liquid 92 can be introduced into the dip tube 66 through the beverage outlet opening 62 with the valve 78 in the open position. This would place flushing liquid 92 between the uppermost surface 94 (see FIG. 5) of the beverage 54 inside the dip tube 66 and the valve 78. The valve 78 can then be closed and the flushing liquid spout 202 can be removed as shown in FIG. 13.

By having liquid contact the valve 78 (or the valve 178 in FIG. 6), the problem of a very foamy head on the first few pours that are dispensed from the vessel 52, 152 is mitigated. With regard to carbonated beverages, and especially beer, the size of the head on the beer is a function of the number of nucleation sites and mechanical agitation, among other factors.

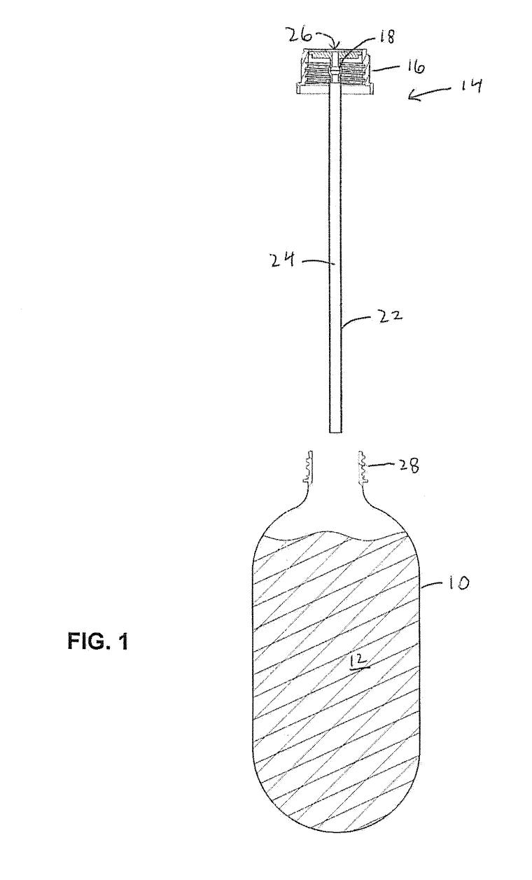

A nucleation site is where a gas bubble can form. A nucleation site can occur where there is a roughened edge, a dust particle or some other imperfection in a fluid passage or a fluid vessel. In the consumable consumer products described in FIGS. 1 and 2, the location where the air is trapped in the dip tube 22 can provide a location for a very large number of nucleation sites. By allowing the liquid, whether it be the beverage 54 itself or the flushing liquid 92, to contact the valve 78, 178 this wets the dip tube 66, 166 and washes many of the nucleation sites. It has been found that using the flushing fluid 92, as opposed to the beverage alone, will result in a smaller head on the first few pours from the vessel 52.

Mechanical agitation, e.g. bumping the vessel that carries the beverage or stirring the beverage, also releases the carbon dioxide entrained in the beverage. By allowing the liquid, whether it be the beverage 54 itself or the flushing liquid 92, to contact the valve 78 the flow of the beverage along the beverage outlet path 68, 168 can more closely approximate a laminar fluid (thus reducing the mechanical agitation) during the initial pour(s) from the vessel. Accordingly, the amount of beverage that is dispensed form the vessel having an unusually large head can be reduced as compared to known systems. This can be particularly useful for vessels that carry about 3 liters of a consumable beverage. Moreover, since only about 3 mL of flushing liquid can be used to provide these advantageous results, the beverage that is first dispensed is not noticeably watered down.

A method for filling a vessel with a gas entrained beverage and a consumable consumer product including the beverage have been described above in particularity. Modifications and alterations will occur to those upon reading and understanding the preceding detailed description. The invention, however, is not limited to only those embodiments described above. Instead, the invention is defined by the appended claims and the equivalents thereof.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method for filling a vessel with a gas entrained beverage comprising:
providing a vessel and a cap assembly, wherein the cap assembly includes a closure including a beverage outlet opening, a hollow dip tube connected with closure and in fluid communication with the beverage outlet opening via a beverage outlet path, and a valve connected to the closure and disposed along the beverage outlet path;
filling the vessel with a gas entrained beverage;
filling the dip tube at least up to the valve with (1) a flushing liquid, (2) the beverage or (3) the flushing liquid and the beverage, wherein the flushing liquid has less entrained gas than the beverage; and
connecting the cap assembly to the vessel to seal the vessel, wherein the dip tube extends into the gas entrained beverage within the vessel.

2. The method of claim 1, further comprising:
opening the valve; and
closing the valve.

3. The method of claim 2, wherein opening the valve and closing the valve are performed before connecting the cap assembly to the vessel.

4. The method of claim 3, wherein filling the dip tube further includes filling the dip tube through the beverage outlet opening.

5. The method of claim 4, wherein filling the dip tube further includes filling the dip tube from an inlet opening of the dip tube.

6. The method of claim 3, wherein filling the dip tube further includes filling the dip tube through an inlet opening at the distal end of the dip tube.

7. The method of claim 6, wherein filling the dip tube further includes filling the dip tube from the inlet opening of the dip tube up to the valve with the flushing liquid.

8. The method of claim 2, wherein opening the valve and closing the valve are performed after connecting the cap assembly to the vessel.

9. The method of claim 8, wherein filling the dip tube is performed with the valve in an open position.

10. The method of claim 9, wherein filling the dip tube includes filling the dip tube with the flushing liquid through the beverage outlet opening.

11. The method of claim 9, wherein opening the valve includes opening the valve until the beverage exits through the beverage outlet opening and closing the valve includes closing the valve after the beverage begins to exit the beverage outlet opening.

12. The method of claim 1, wherein connecting the cap assembly to the vessel includes threading the cap assembly onto the vessel.

13. The method of claim 1, wherein connecting the cap assembly to the vessel includes crimping the cap assembly onto the vessel

14. A consumable consumer product comprising:
a vessel;
a gas entrained beverage inside the vessel;
a closure connected with the vessel to seal the beverage in the vessel, the closure including a beverage outlet opening;
a seal removably connected with the closure, the seal covering the beverage outlet opening when connected with the closure and the beverage outlet opening being open to ambient when the seal has been removed from the closure;
a hollow dip tube connected with the closure and extending into the vessel, the dip tube being in fluid communication with the beverage outlet opening via a beverage outlet path at least partially defined by the dip tube; and
a valve connected with the dip tube and in the beverage outlet path for selectively blocking the beverage from the beverage outlet opening, wherein when the vessel is in an upright position an uppermost level of the beverage inside the vessel but outside the dip tube is spaced below the beverage outlet opening, and when in the upright position a liquid is in contact with the valve prior to the seal being removed from the closure.

15. The product of claim 14, wherein the liquid that is in contact with the valve is the beverage.

16. The product of claim 14, further comprising a flushing liquid having less entrained gas than the beverage, wherein the flushing liquid is disposed in the dip tube.

17. The product of claim 14, wherein the beverage has a volume of at least x mL and the flushing liquid has a volume of less than about 0.001x mL.

18. The product of claim 16, wherein the dip tube is filled with the flushing liquid from adjacent a distal end of the dip tube to a valve of the dip tube.

19. The product of claim 16, wherein the liquid that is in contact with the valve is the flushing liquid.

20. The product of claim 16, wherein the gas entrained beverage is beer and the flushing liquid is water.
